(19) United States
(12) Patent Application Publication
(10) Pub. No.: US 2011/0267289 A1
(43) Pub. Date: Nov. 3, 2011

(54) TOUCH SCREEN PANEL AND IMAGE DISPLAY DEVICE HAVING THE SAME

(75) Inventors: Jung-Mok Park, Yongin-City (KR); Sun-Haeng Cho, Yongin-City (KR); Choon-Hyop Lee, Yongin-City (KR)

(73) Assignee: Samsung Mobile Display Co., Ltd., Yongin-city (KR)

(21) Appl. No.: 12/951,506

(22) Filed: Nov. 22, 2010

(30) Foreign Application Priority Data
Apr. 28, 2010 (KR) 10-2010-0039541

(51) Int. Cl. G06F 3/041

(52) U.S. Cl. 345/173

(57) ABSTRACT

A touch screen panel having a simple structure, in which the touch screen panel includes a transparent substrate having a touch active region and a touch inactive region disposed in an edge portion of the touch active region; sensing patterns formed in the touch active region of the transparent substrate, and including: first sensing cells connected along a first direction by first connecting patterns, and second sensing cells connected along a second direction by second connecting patterns; an edge pattern layer formed in a side of the transparent substrate having the sensing patterns; and an insulating layer disposed between the first connecting patterns and the second connecting patterns, wherein the insulating layer is disposed where the first connecting patterns intersect the second connecting patterns, and wherein the insulating layer is made of a same material as a material of the edge pattern layer.

### CROSS-REFERENCE TO RELATED APPLICATION

This application claims the benefit of Korean Patent Application No. 10-2010-0039541, filed Apr. 28, 2010, in the Korean Intellectual Property Office, the disclosure of which is incorporated herein by reference.

### BACKGROUND

1. Field

Aspects of the present invention relate to a touch screen panel and an image display device having the same, and more particularly, to a touch screen panel having a simple structure and an image display device having the same.

2. Description of the Related Art

A touch screen panel is an input device to select content displayed on a screen, such as an image display device, using a person's hand or an object to input commands of a user. The touch screen panel is provided on a front face of the image display device and converts positions of a point contacting the person's hand or the object into electrical signals. Accordingly, the instruction selected at the contact point is received as an input signal. The touch screen panel can replace a separate input device, such as a keyboard or a mouse, that connects to the image display device to select content displayed on the image display device. Thus, use of the touch screen panel is increasing.

The touch screen panel recognizes a touch as an input signal, in which the touch occurs on a screen region of the touch screen panel. A conductive sensing cell, disposed in the screen region of the touch screen panel displaying the image, recognizes the touch. In other words, when the image display device includes the touch screen panel, the screen region has a touch active region receiving a touch input as well as a display region displaying the image.

An edge portion of the screen region has wirings arranged therein, the wiring including signal lines, power lines, and the like. The wirings connect the display region to the touch active region. The edge portion has an edge pattern layer 20 (see FIG. 3A), such as a black matrix, and the like, to prevent the wirings from being viewed, and also has a touch inactive region. To this end, a window substrate, or a similar element, is disposed in an uppermost portion of the image display device, and is formed to have the edge pattern layer 20 to correspond with the black matrix.

However, a conventional image display device having the touch screen panel includes the touch screen panel, having a transparent substrate including the conductive sensing cells, and the like, and the window substrate disposed in an upper portion of the touch screen panel.l In addition, the conventional image display device includes the display panel displaying the image. Therefore, a structure of the conventional image display device is relatively complex, and thus there is a disadvantage that a thickness of the image display device increases.

### SUMMARY

Aspects of the present invention provide a touch screen panel having a simple structure, and an image display device having the same.

Aspects of the present invention provide a touch screen panel including: a transparent substrate including: a touch active region, and a touch inactive region disposed in an edge portion of the touch active region; sensing patterns formed in the touch active region, comprising: first sensing cells connected along a first direction by first connecting patterns, and second sensing cells connected along a second direction by second connecting patterns; an edge pattern layer formed in a side of the transparent substrate having the sensing patterns; and an insulating layer disposed between the first connecting patterns and the second connecting patterns, wherein the insulating layer is disposed where the first connecting patterns intersect the second connecting patterns, and wherein the insulating layer is made of a same material as a material of the edge pattern layer.

According to another aspect of the present invention, the edge pattern layer and the insulating layer are made of a same opaque insulating material.

According to another aspect of the present invention, the edge pattern layer and the insulating layer are made of a same insulating black matrix material.

According to another aspect of the present invention, the edge pattern layer and the insulating layer are made of a same color photo resist.

According to another aspect of the present invention, the insulating layer is disposed between the first connecting patterns and the second connecting patterns so as to not overlap with the first sensing cells and the second sensing cells.

According to another aspect of the present invention, the first connecting patterns are disposed in a layer closer to the transparent substrate than a layer having the second connecting patterns, wherein the insulating layer is disposed on the first connecting patterns so as to expose regions of the first connecting patterns, wherein the edge pattern layer is formed in the touch inactive region, wherein the second sensing cells are formed between the first sensing cells and are formed to be one body with the second connecting patterns over an upper portion of the insulating layer.

According to another aspect of the present invention, the first sensing cells, the second sensing cells, and the second connecting patterns are made of a same material and in a same layer in the touch active region, wherein the insulating layer is formed on the second connecting patterns, wherein the edge pattern layer is formed in the touch inactive region, and wherein the first connecting patterns are connected to the first sensing cells over an upper portion of the insulating layer.

According to another aspect of the present invention, the transparent substrate is a window substrate disposed in an uppermost portion among substrates included in an image display device, and wherein the sensing patterns, the insulating layer, and the edge pattern layer are formed in a bottom side of the transparent substrate, and wherein the bottom side is opposite to a touch side of the transparent substrate.

According to an aspect of the present invention, there is provided an image display device including: a display panel displaying an image; and a touch screen panel receiving a touch input and disposed in an upper portion of the display panel, wherein the touch screen panel includes: a transparent substrate including a touch active region, and a touch inactive region disposed in an edge portion of the touch active region; sensing patterns formed in the touch active region of the transparent substrate, and including: first sensing cells connected along a first direction by first connecting patterns, and second sensing cells connected along a second direction by second connecting patterns; an edge pattern layer formed in a side of the transparent substrate having the sensing patterns; and an insulating layer disposed between the first connecting patterns and the second connecting patterns, wherein the insulating layer is disposed where the first connecting patterns intersect the second connecting patterns, and, wherein the insulating layer is made of a same material as a material of the edge pattern layer.

According to another aspect of the present invention, the transparent substrate of the touch screen panel is a window substrate disposed in an uppermost portion of the image display device, and wherein the window substrate is directly contacted by a contact object performing a touch input.

According to aspects of the present invention, the sensing cells are formed in the touch active region and include the first and the second sensing cells connected along the first and the second directions by the first and the second connecting patterns, respectively. The edge pattern layer is formed in the touch inactive region along the edge portion of the touch active region and are formed in the same transparent substrate as the touch active region and the touch inactive region. Also the insulating layer disposed between the first and the second connecting patterns and the edge pattern layer are made of a same material and in a same manufacturing process.

In other words, according to aspects of the present invention, the insulating layer insulating between the first sensing cells and the second sensing cells is made of the material used to form the edge pattern layer and is formed in a same manufacturing process forming the edge pattern layer.

Thus, advantages such as a simple structure and a reduced thickness of the touch screen panel and the image display device having the touch screen panel may be achieved. Also, a process to manufacture the touch screen panel and the image display device are simple, and thus, a cost to manufacture the touch screen panel and the image display device is reduced.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view showing a touch screen panel according to an embodiment of the present invention;

FIG. 2 is an enlarged view showing a principle part of sensing patterns according to an embodiment of the present invention;

FIGS. 3A and 3B are cross-sectional views showing a touch screen panel having sensing patterns as depicted in FIG. 2;

FIG. 4 is an enlarged view showing a principle part of sensing patterns according to other embodiment of the present invention; and

FIGS. 5A and 5B are cross-sectional views showing a touch screen panel having sensing patterns as depicted in FIG. 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As referred to herein, when a first element, item or layer is said to be disposed or formed “on”, or “adjacent to”, a second element, item or layer, the first element, item or layer can directly contact the second element, item or layer, or can be separated from the second element, item or layer by one or more other elements, items or layers located therebetween. In contrast, when an element, item or layer is referred to as being disposed or formed “directly on” another element, item or layer, there are no intervening elements, items or layers present.

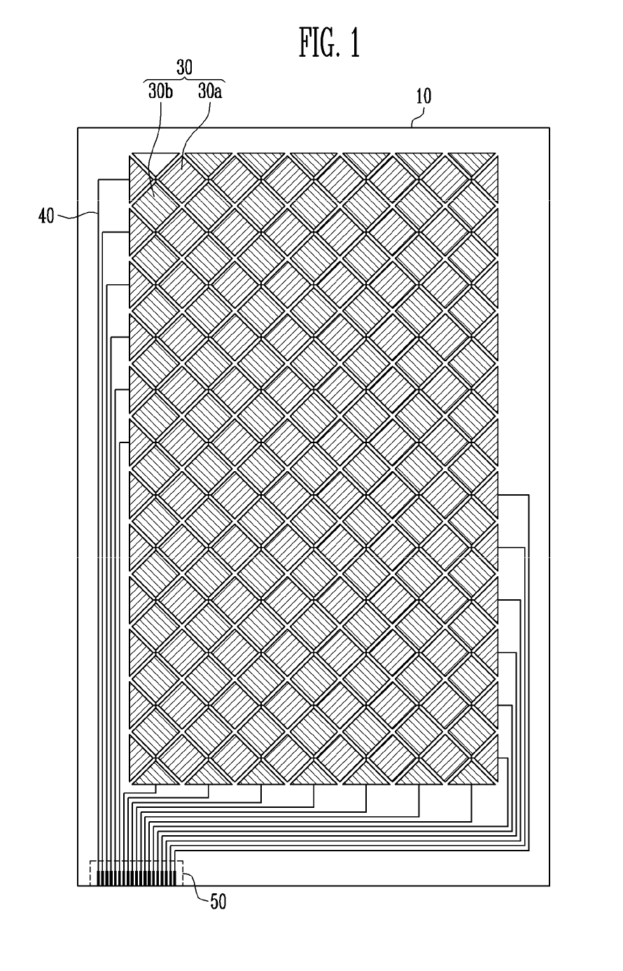

FIG. 1 is a plan view showing a touch screen panel according to an embodiment of the present invention. Referring to FIG. 1, a touch screen panel includes a transparent substrate 10, a plurality of sensing patterns 30 formed on the transparent substrate 10, and position detecting lines 40 connecting the sensing patterns 30 to an external driving circuit through a pad unit 50.

The transparent substrate 10 is made of a transparent substrate material, such as a glass, a polyethylene terephthalate (PET), or an acryl. According to aspects of the present invention, transparency refers to a high light transmission rate as well as 100% transparency.

The transparent substrate 10 includes a touch active region having the sensing patterns 30, and a touch inactive region that is disposed at an edge portion of the touch active region. The transparent substrate 10 also has the position detecting lines 40 and the pad unit 50.

The sensing patterns 30 are formed in the touch active region on one side of the transparent substrate 10. The sensing patterns 30 include first sensing cells 30a connected along a first direction and second sensing cells 30b connected along a second direction. The first sensing cells 30a and the second sensing cells 30b are formed of a transparent electrode material, such as indium-tin-oxide (ITO). However, aspects of the present invention are not limited thereto, and the first and second sensing cells 30a, 30b may be formed of other suitable materials.

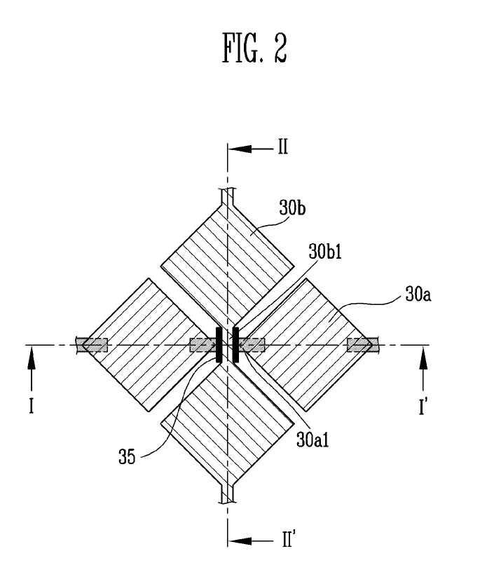

In addition, the sensing patterns 30 further include first connecting patterns 30a1 (see FIG. 2) and second connecting patterns 30b1 (see FIG. 2). The first and second connecting patterns 30a1, 30b1 respectively connect the first sensing cells 30a and the second sensing cells 30b along the first direction and the second direction. In other words, the sensing patterns 30 include the first and second sensing cells 30a, 30b, which are formed in the touch active region, to receive a touch input, and also include the first and second connecting patterns 30a1, 30b1 connecting the first and second sensing cells 30a, 30b.

The first sensing cells 30a are connected in the first direction, i.e., in a row direction, to respectively connect to position detecting lines 40 in the rows. The second sensing cells 30b are connected in the second direction, which is a column direction intersecting with the first direction. The second sensing cells 30b are disposed between the first sensing cells 30a, thereby connecting to position detecting lines 40 corresponding to the column direction.

The first sensing cells 30a and the second sensing cells 30b are respectively connected in the first direction and the second direction by the first connecting patterns 30a1 and the second connecting patterns 30b1 (see FIG. 2). The first and second sensing cells 30a, 30b are disposed in a same layer, but include an insulating layer 35 (see FIG. 2) disposed between them. However, aspects of the present invention are not limited thereto, and the first sensing cells 30a and the second sensing cells 30b may be disposed in different layers.

The position detecting lines 40 connect the sensing patterns 30 to the external driving circuit (not shown), such as the position detecting circuit, through the pad unit 50. The position detecting lines 40 are disposed in the touch inactive region of the edge portion of the touch screen panel. The position detecting lines 40 are not disposed in the touch active region displaying the image. The position detecting lines 40 may be formed of a low-resistance material, such as Mo, Ag, Ti, Cu, Ti, Mo/Al/Mo. Alternatively, the position detecting lines 40 may be formed of a same material as the transparent electrode materials used to form the first and second sensing cells 30a, 30b. However, aspects of the present invention are not limited thereto, and the position detecting lines 40 may be formed of other suitable materials.

The touch screen panel, as described above, is a capacitive touch screen panel. When the contact objects, such as human hand, a stylus pen, and the like, contact the touch screen panel, a change of the electrostatic capacitance corresponding to the contact position is transmitted from the sensing patterns 30 to the driving circuit (not shown) through the position detecting lines 40 and the pad unit 50. Subsequently, the contact position, as the change of the electrostatic capacity, is converted to an electric signal through X and Y input processing circuit (not shown) in order to confirm the contact position.

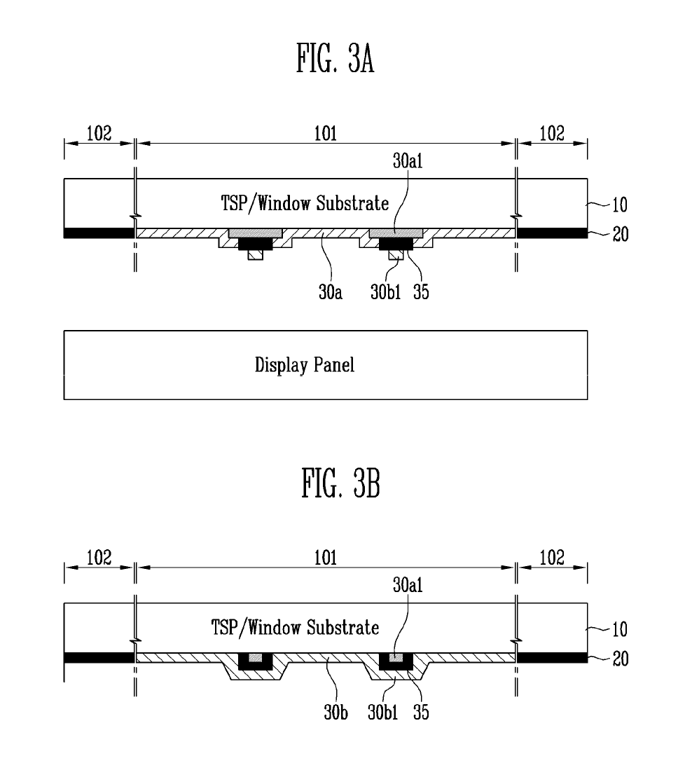

Although not shown in FIG. 1, one side of the transparent substrate 10 further includes an edge pattern layer 20 (see FIG. 3A) that prevents viewing of a pattern of the position detecting lines 40, and the like. The edge pattern layer also forms an edge in the screen by being disposed in the touch inactive region and overlapping with the position detecting lines 40.

In other words, according to the present embodiment, the sensing patterns 30 and the edge pattern layer are formed on a same transparent substrate 10. Also, the insulating layer 35 (see FIG. 2), which insulates the first sensing cells 30a and the second sensing cells 30b from each other, and the edge pattern layer are formed in a same layer in a same manufacturing operation by using a same material. Thus, the touch screen panel and the image display device having the touch screen panel have a simple structure, and a simple manufacturing, as well as a reduced thickness.

FIG. 2 is an enlarged view showing a principal part of sensing patterns 30 according to an embodiment of the present invention. FIG. 3 is a cross-sectional view showing a touch screen panel having the sensing patterns 30 as depicted in FIG. 2. Referring to FIG. 2, the sensing patterns 30 include the first and the second sensing cells 30a, 30b, and the first and the second connecting patterns 30a1, 30b1.

The first sensing cells 30a are patterned to each be an independent shape and are connected in the first direction by the first connecting patterns 30a1. The first connecting patterns 30a1 are made of the transparent electrode material used to form the first sensing cells 30a. However, aspects of the present invention are not limited thereto, and the first connecting patterns 30a1 may be made of a low-resistance opaque electrode material. When the first connecting patterns 30a1 are made of the opaque electrode material, viewing of the first connecting patterns 30a1 is prevented by controlling a width, length, or thickness of the first connecting patterns 30a1.

The second sensing cells 30b are formed to be one body with the second connecting patterns 30b1 and are connected in the second direction. In this case, the insulating layer 35 is disposed between the first connecting patterns 30a1 and the second connecting patterns 30b1. The insulating layer 35 is disposed at a portion of the first connecting patterns 30a1 and the second connecting patterns 30b1 that intersect each other, for example, at right angles, in order to insulate the first sensing cells 30a and the second sensing cells 30b.

In other words, the first connecting patterns 30a1 and the second connecting patterns 30b1 have the insulating layer 35 disposed between them, and the first connecting patterns 30a1 and the second connecting patterns 30b1 are disposed in different layers from each other. For example, the first connecting patterns 30a1 are formed under the insulating layer 35, and the first sensing cells 30a, the second sensing cells 30b, and the second connecting patterns 30b1 are disposed above the insulating layer 35.

Hereinafter, the touch screen panel having the sensing patterns 30, as depicted in FIG. 2, will be described in more detail with reference to the cross-sectional view of FIGS. 3A and 3B. FIG. 3A is a cross-sectional view taken along line I-I′ of FIG. 2 and FIG. 3B is a cross-sectional view taken along line II-II′ of FIG. 2. Referring to FIGS. 3A and 3B, the transparent substrate 10 includes a touch active region 101 and a touch inactive region 102 disposed at an edge portion of the touch active region 101.

The touch active region 101 includes the sensing patterns 30 including the first and the second sensing cells 30a, 30b, and the first and the second connecting patterns 30a1, 30b1. The touch inactive region 102 includes an edge pattern layer 20, which may be a black matrix, in a same side as a side having the sensing patterns 30. In other words, the sensing patterns 30 and the edge pattern layer 20 are formed on one side of the same transparent substrate 10.

In this case, when the sensing patterns 30 and the edge pattern layer 20 are formed on the same transparent substrate 10, the transparent substrate 10 is a window substrate disposed in an uppermost portion of substrates included in the image display device. In other words, the touch screen panel, according to the present embodiment, may be implemented as the touch screen panel integrated with the window substrate.

In this case, the sensing patterns 30, the black matrix 20, and the insulating layer 35 are formed in a bottom side of the transparent substrate 10. The bottom side of the transparent substrate 10 is opposite a touch side of the transparent substrate 10. Also, in the present case, the sensing patterns 30 include the first and the second sensing cells 30a, 30b and the first and the second connecting patterns 30a1, 30b1. Also, although not shown, the insulating layer 35 may include a first insulating layer 35a and a second insulating layer 35b, wherein the first and second insulating layers 35a, 35b may be disposed on or between the first and second connecting patterns 30a1, 30b1.

In the present embodiment, the insulating layer 35, disposed between the first and second connecting patterns 30a1, 30b1 is formed using a same material as a material of the edge pattern layer 20 and is formed in a same manufacturing operation forming the edge pattern layer 20.

In this case, the edge pattern layer 20 is made of a material having black color to form the black matrix. However, aspects of the present invention are not limited thereto, and the edge pattern layer 20 may be formed of a material of opaque colors. The edge pattern layer 20 prevents viewing of wiring, and the like. Therefore, the edge pattern layer 20 and the insulating layer 35 may be made of a same opaque insulating material. For example, when implementing the black matrix in the touch screen panel, the edge pattern layer 20 and the insulating layer 35 may be made of the same opaque insulating black matrix material. Alternatively, when implementing a color edge in the touch screen panel, the edge pattern layer 20 and the insulating layer 35 may be made of a colored insulating material of the same material, such as color photo resist, and the like.

However, the insulating layer 35, according to the present embodiment, is made of the opaque insulating material. Thus, the insulating layer 35 is not formed in the touch active region 101 and, rather, the insulating layer 35 is disposed at the intersection portion of the first and the second connecting patterns 30a1, 30b1. For example, the first insulating layer 35 is disposed between the first and the second connecting patterns 30a1, 30b1 so as to not overlap with the first and the second sensing cells 30a, 30b. In this case, controlling an area, a thickness, and the like of the insulating layer 35 can prevent a deterioration of a transmission rate of the touch active region 101.

In the present embodiment, the touch screen panel is formed in a structure having the first connecting patterns 30a1 in a layer closer to the transparent substrate 10 in comparison to a layer having the second connecting patterns 30b1. Also, the insulating layer 35 is formed on the first connecting patterns 30a1 to expose a region of the first connecting patterns 30a1, and the edge pattern layer 20 is formed only in the touch inactive region 102.

In addition, the first sensing cells 30a are formed in the touch active region 101 and are connected to the first connecting patterns 30a1 through the exposed region of the first connecting patterns 30a1. The second sensing cells 30b are formed in the touch active region 101 between the first sensing cells 30a and are formed to be one body with the second connecting patterns 30b1 via an upper region of the insulating layer 35.

Therefore, in order to manufacture the touch screen panel according to aspects of the present invention, first, the first connecting patterns 30a1 are formed on one side of the transparent substrate 10 in the touch active region 101 of the transparent substrate 10. Next, the insulating layer 35 is formed on the first connecting patterns 30a1 and the edge pattern layer 20 is formed in the touch inactive region 102 on the one side of the transparent substrate 10. Thus, the insulating layer 35 exposes one region of the first connecting patterns 30a1 on the one side of the transparent substrate 10.

Next, a transparent electrode layer is formed on the one side of the transparent substrate 10 having the first connecting patterns 30a1, the insulating layer 35, and the edge pattern layer 20. Subsequently, the first sensing cells 30a, the second sensing cells 30b, and the second connecting patterns 30b1 are formed by patterning the transparent electrode layer.

The insulating layer 35 and the edge pattern layer 20 are made of the same material and at the same manufacturing operation according to aspects of the present invention. However, the insulating layer 35 and the edge pattern layer 20 should satisfy conditions that prevent the position detecting lines 40 from being visible, and should provide insulating properties between the first and the second connecting patterns 30a1, 30b1. To this end, the insulating layer 35 and the edge pattern layer 20 are made of the opaque insulating material, such as the insulating black matrix, color photo resist, and the like as mentioned above.

For convenience of illustration, the position detecting lines 40, as depicted in FIG. 1, are not illustrated in FIG. 3. However, the position detecting lines 40 are disposed to overlap with the edge pattern layer 20 in the transparent substrate 10. Also, the position detecting lines 40 are disposed closer to the display panel rather than the edge pattern layer 20. Also, in the present embodiment, the display panel is disposed in a bottom portion of the touch screen panel, and a pixel region of the display panel is disposed to overlap with the touch active region 101.

In other words, the image display device having the touch screen panel includes the display panel displaying the image, and the touch screen panel is disposed in the upper portion of the display panel. Specifically, the touch screen panel, according to the present embodiment is implemented as the touch screen panel having the window. In such a case, the transparent substrate 10 is the window substrate disposed in an uppermost portion of the image display device. Thus, the contact object contacts the window substrate to perform the touch input on the image display device.

Therefore, according to aspects of the present invention, in the image display device having the touch screen panel having the window, there are advantages such as a thickness of the touch screen panel being small and a cost of manufacturing the touch screen panel is reduced because a separate window substrate is not needed. Additionally, the insulating layer 35 is formed using a same material used to form the edge pattern layer 20.

More specifically, the sensing patterns 30 and the edge pattern layer 20 are formed on the same transparent substrate 10. Also, the insulating layer 35 and the edge pattern layer 20 are formed in the same manufacturing process by using the same material. In other words, aspects of the present invention provide that the edge pattern layer 20 and the insulating layer 35 are formed at the same time. Thus, the structures of the touch screen panel and the image display device and the methods of manufacturing the same can be simple, and also, their thickness can be reduced.

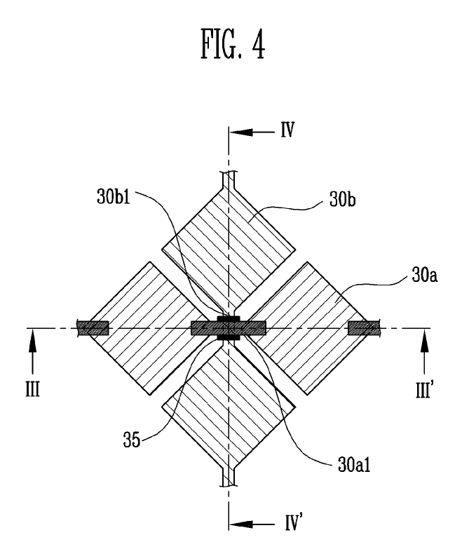

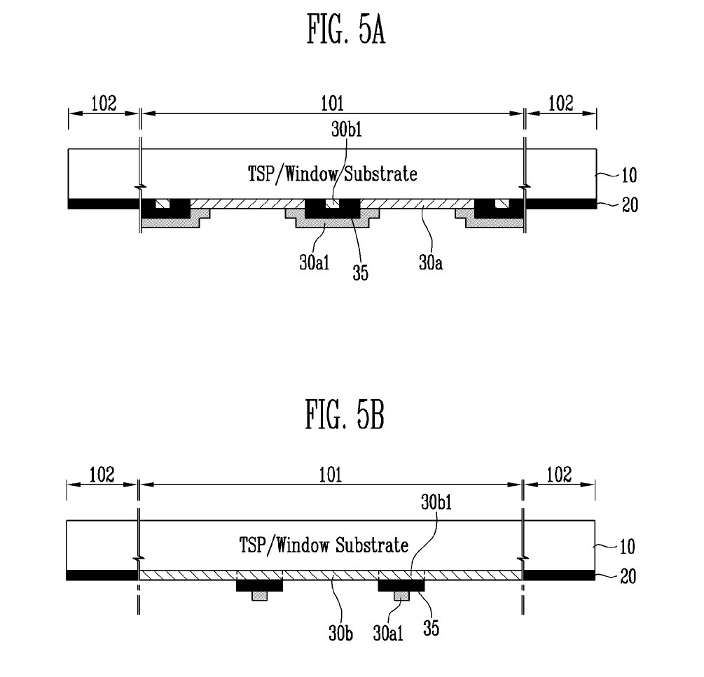

FIG. 4 is an enlarged view showing a principle part of the sensing patterns 30, according to another embodiment of the present invention. FIGS. 5A and 5B are cross-sectional views showing a touch screen panel having the sensing patterns 30 as depicted in FIG. 4. ]FIG. 5A is a cross-sectional view taken along line III-III′ of FIG. 4 and FIG. 5B is a cross-sectional view taken along line IV-IV′.

In FIG. 4 and FIGS. 5A and 5B, a same or similar components as those in FIG. 2 and FIGS. 3A and 3B are indicated by the same reference numerals, and a detailed description thereof is not provided. Referring to FIG. 4 and FIGS. 5A and 5B, the first sensing cells 30a1 are disposed in an upper portion of the insulating layer 35, and the second sensing cells 30b are disposed in a bottom portion of the insulating layer 35. Thus, the second sensing cells 30b are closer to the transparent substrate than the first connecting patterns 30a1.

More specifically, the first sensing cells 30a, the second sensing cells 30b, and the second connecting patterns 30b1 are formed in the touch active region 101 on one side of the transparent substrate 10. In this case, the first sensing cells 30a are disposed between the second sensing cells 30b so as to separate adjacent ones of the second sensing cells 30b. Also, the second sensing cells 30b and the second connecting patterns 30b1 are formed to be one body. The insulating layer 35 is formed on the second connecting patterns 30b1. The edge pattern layer 20 is formed only in the touch inactive region 102.

Additionally, the first connecting patterns 30a1 are formed to connect to the first sensing cells 30a via the upper portion of the insulating layer 35 in the touch active region 101. The touch active region 101 is disposed on one side of the transparent substrate 10 having the first and the second sensing cells 30a, 30b, the second connecting patterns 30b1, and the insulating layer 35.

According to aspects of the present invention, the structure of the touch screen panel and the image display device, according to the embodiment of depicted in FIG. 4 and FIGS. 5A and 5B can be simple, and the methods of manufacturing the touch screen panel and the image display device can be simple. Furthermore, a thickness of the touch screen panel and the display device can be reduced as shown in the embodiment depicted in FIG. 2 and FIGS. 3A and 3B.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A touch screen panel comprising:
a transparent substrate comprising:
a touch active region, and
a touch inactive region disposed in an edge portion of the touch active region;
sensing patterns formed in the touch active region, comprising:
first sensing cells connected along a first direction by first connecting patterns, and
second sensing cells connected along a second direction by second connecting patterns;
an edge pattern layer formed in a side of the transparent substrate having the sensing patterns; and
an insulating layer disposed between the first connecting patterns and the second connecting patterns,
wherein the insulating layer is disposed where the first connecting patterns intersect the second connecting patterns, and
wherein the insulating layer is made of a same material as a material of the edge pattern layer.

2. The touch screen panel as claimed in claim 1, wherein the edge pattern layer and the insulating layer are made of a same opaque insulating material.

3. The touch screen panel as claimed in claim 1, wherein the edge pattern layer and the insulating layer are made of a same insulating black matrix material.

4. The touch screen panel as claimed in claim 1, wherein the edge pattern layer and the insulating layer are made of a same color photo resist.

5. The touch screen panel as claimed in claim 1, wherein the insulating layer is disposed between the first connecting patterns and the second connecting patterns so as to not overlap with the first sensing cells and the second sensing cells.

6. The touch screen panel as claimed in claim 1, wherein the first connecting patterns are disposed in a layer closer to the transparent substrate than a layer having the second connecting patterns,
wherein the insulating layer is disposed on the first connecting patterns so as to expose regions of the first connecting patterns,
wherein the edge pattern layer is formed in the touch inactive region, and
wherein the second sensing cells are formed between the first sensing cells and are formed to be one body with the second connecting patterns over an upper portion of the insulating layer.

7. The touch screen panel as claimed in claim 1, wherein the first sensing cells, the second sensing cells, and the second connecting patterns are made of a same material and in a same layer in the touch active region,
wherein the insulating layer is formed on the second connecting patterns,
wherein the edge pattern layer is formed in the touch inactive region, and
wherein the first connecting patterns are connected to the first sensing cells over an upper portion of the insulating layer.

8. The touch screen panel as claimed in claim 7, wherein the second sensing cells and the second connecting patterns are formed to be one body.

9. The touch screen panel as claimed in claim 1, wherein the transparent substrate is a window substrate disposed in an uppermost portion among substrates included in an image display device,
wherein the sensing patterns, the insulating layer, and the edge pattern layer are formed in a bottom side of the transparent substrate, and
wherein the bottom side is opposite to a touch side of the transparent substrate.

10. An image display device comprising:
a display panel displaying an image; and
a touch screen panel receiving a touch input and disposed in an upper portion of the display panel,
wherein the touch screen panel comprises:
a transparent substrate comprising:
a touch active region, and
a touch inactive region disposed in an edge portion of the touch active region,
sensing patterns formed in the touch active region of the transparent substrate, and comprising:
first sensing cells connected along a first direction by first connecting patterns, and
second sensing cells connected along a second direction by second connecting patterns,
an edge pattern layer formed in a side of the transparent substrate having the sensing patterns, and
an insulating layer disposed between the first connecting patterns and the second connecting patterns,
wherein the insulating layer is disposed where the first connecting patterns intersect the second connecting patterns, and
wherein the insulating layer is made of a same material as a material of the edge pattern layer.

11. The image display device as claimed in claim 10, wherein the edge pattern layer and the insulating layer are made of a same opaque insulating material.

12. The image display device as claimed in claim 10, wherein the edge pattern layer and the insulating layer are made of a same insulating black matrix material.

13. The image display device as claimed in claim 10, wherein the edge pattern layer and the insulating layer are made of a same color photo resist.

14. The image display device as claimed in claim 10, wherein the insulating layer is disposed between the first connecting patterns and the second connecting patterns so as to not overlap with the first sensing cells and the second sensing cells.

15. The image display device as claimed in claim 10, wherein the transparent substrate of the touch screen panel is a window substrate disposed in an uppermost portion of the image display device, and
wherein the window substrate is directly contacted by a contact object performing a touch input.

16. The touch screen panel as claimed in claim 1, wherein the edge pattern layer is formed only in the touch inactive region.

17. The touch screen panel as claimed in claim 1, further comprising:
a pad unit connecting the touch screen panel to an external drive circuit; and
position detecting lines connecting the sensing patterns to the pad unit.

18. The touch screen panel of claim 17, wherein the edge pattern layer is formed over the position detecting lines.

19. A touch screen panel comprising:
a transparent substrate having a touch active region and a touch inactive region disposed in an edge portion of the touch active region;
sensing patterns formed in the touch active region;
an edge pattern layer formed in a side of the transparent substrate having the sensing patterns; and
an insulating layer disposed on the transparent substrate,
wherein the insulating layer is made of a same material as a material of the edge pattern layer.

20. The touch screen panel of claim 19, wherein each of the sensing patterns comprise:
first sensing cells connected along a first direction by first connecting patterns; and
second sensing cells connected along a second direction by second connecting patterns,
wherein the insulating layer is disposed between the first connecting patterns and the second connecting patterns, and
wherein the insulating layer is disposed where the first connecting patterns intersect the second connecting patterns.
